(19) United States
(12) Patent Application Publication
(10) Pub. No.: US 2005/0214035 A1
(43) Pub. Date: Sep. 29, 2005

(54) Electrophotographic image forming method and apparatus for preventing color shift

(76) Inventor: Takuro Kamiya, Suginami-Ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/045,292

(22) Filed: Jan. 31, 2005

(30) Foreign Application Priority Data
Jan. 30, 2004 (JP) 2004-024813

(51) Int. Cl. G03G 15/01

(52) U.S. Cl. 399/301

(57) ABSTRACT

An image forming apparatus includes at least one image bearing member, a transport mechanism, a scale, and a scale reading mechanism. The at least one image bearing member is configured to bear a toner image on a surface thereof. The transport mechanism has inner and outer surfaces and transports the toner image. The outer surface is configured the toner image from the at least image bearing member. The scale includes a plurality of thin film marks arranged along the inner surface of the transport mechanism at predetermined intervals in a moving direction of the transport mechanism. The scale reading mechanism includes a magnetometric sensor to magnetometrically read the plurality of marks forming the scale.

### CROSS REFERENCE TO RELATED APPLICATIONS

The present patent document claims priority under 35 U.S.C. §119 to Japanese Patent Application No. 2004-024813 filed on Jan. 30, 2004 in the Japanese Patent Office, the entire contents of which are hereby incorporated herein by reference.

### BACKGROUND OF THE INVENTION

1. Field of the Invention

The present invention relates to a method and apparatus for reducing a color shift of respective color images during electrophotographic image forming. The present invention further relates to a method and apparatus for maintaining a reading accuracy of a sensor employed to prevent a color shift of respective color images during electrophotographic image forming.

2. Discussion of the Background

Electrophotographic image forming apparatuses including copiers, printers, facsimile machines, printing presses and the like generally produce an image by forming an electrostatic latent image on an electrostatic latent image bearing member, developing the electrostatic latent image as a toner image, and transferring the toner image onto a recording sheet.

Some electrophotographic image forming apparatuses are specialized in producing black-and-white images. Some other electrophotographic image forming apparatuses produce full-color images in addition to producing black-and-white images. The former image forming apparatuses are referred to as monochrome image forming apparatuses and include a monochrome copier, a monochrome printer, etc. The latter image forming apparatuses are referred to as color image forming apparatuses and include a color copier, a color printer, etc.

The color image forming apparatuses are commonly classified as one-drum image forming apparatuses and tandem-type image forming apparatuses.

The one-drum image forming apparatus includes one photoconductive element serving as an electrostatic latent image bearing member in a form of a drum. Around the photoconductive element are a plurality of image forming units. The number of the plurality of image forming units corresponds to the number of colors of toner. Each of the image forming units includes various image forming components, such as, for example, a charging unit, a developing unit and a cleaning unit. These image forming units apply respective toners of different colors to sequentially form each of respective toner images on a surface of the photoconductive element. These respective toner images are then overlaid onto a recording sheet so that a full-color image is formed.

The tandem-type image forming apparatus includes a plurality of photoconductive elements and a plurality of image forming units corresponding to the plurality of respective photoconductive elements. The plurality of image forming units develop respective color toner images of different colors on the plurality of respective photoconductive elements. These color toner images are sequentially transferred onto a recording sheet to form a full-color image.

When comparing the one-drum image forming apparatus and the tandem-type image forming apparatus, the following differences between the two image forming apparatuses may be found.

While the plurality of photoconductive elements make the tandem-type image forming apparatus larger and more expensive, the one photoconductive element makes the one-drum image forming apparatus relatively compact and inexpensive. On the other hand, when the one-drum image forming apparatus needs to repeat its image forming operation several times (generally four times) to develop a full-color image, the tandem-type image forming apparatus can reduce a time period of the image forming operation because of simultaneous operations of a plurality of photoconductive elements.

The tandem-type image forming apparatus includes a direct transfer system or an indirect transfer system.

In the direct transfer system, a plurality of photoconductive elements are arranged in parallel with a surface of a sheet transfer belt that forms an endless belt, and a plurality of transfer units having respective colors of yellow (y), magenta (m), cyan (c), and black (bk) are disposed in a vicinity of the plurality of respective photoconductive elements. Respective color toner images formed on surfaces of the plurality of photoconductive elements are sequentially transferred by the plurality of transfer units onto a recording sheet that is conveyed by the sheet transfer belt.

In the indirect transfer system, a plurality of photoconductive elements are arranged in parallel with a surface of an intermediate transfer member forming an endless belt. Respective color toner images formed on surfaces of the plurality of photoconductive elements are sequentially transferred and overlaid by a plurality of respective primary transfer units onto a surface of the intermediate transfer member so that an overlaid color toner image is formed. Subsequently, a secondary transfer unit transfers the overlaid color toner image onto a recording sheet. The secondary transfer unit may employ a transfer belt system or a roller system.

Since the market requires a color image forming apparatus that performs its image forming operations at a speed equivalent to the monochrome image forming apparatus, the tandem-type image forming apparatus tends to be more employed when compared to the one-drum image forming apparatus.

It has been a significant challenge to overlay a plurality of color toner images having different colors onto a transfer member without color shift caused by a transfer misalignment between the plurality of color toner images so as to prevent deterioration in quality of an image production. To achieve the above-described purpose, attempts have been made to detect a moving distance of a moving member by reading encoder marks.

To prevent color shift caused by a transfer misalignment between the plurality of color toner,a linear encoder having encoder marks is provided on a surface of a moving member (e.g., a transfer belt) of the tandem-type image forming apparatus. By measuring a surface speed with the linear encoder, variations of the surface speed of the moving member may be detected.

The linear encoder performs a feedback control according to results of the detection and uses the results to adjust the rate for writing. This system may efficiently be used to achieve accurate alignment. In a case in which the endless belt has a surface that is clear and transparent, the encoder marks may be printed on the clear surface of the endless belt, so that the linear encoder can read the encoder marks with an optical sensor to measure a surface speed of the endless belt. However, an endless belt typically includes conductive materials such as carbon material, which prevents the surface of the endless belt from being clear and transparent. As an alternative to the clear surface, a reflective linear encoder may be provided on the endless belt. The reflective linear encoder generally includes a metal etching or printing layer to obtain high reflectance. However, the reflectance of the metal etching or printing layer may change with age.

In addition, toner dust may adhere to and accumulate on the linear encoder arranged on a transfer belt, which causes a misreading of the encoder marks by the optical sensor. To avoid the misreading, a contact-type cleaning mechanism may be arranged to clean a surface of the transfer belt. However, the contact-type cleaner may scratch the surface of the transfer belt, resulting in an occurrence of a misdetection by the optical sensor. Further, the optical sensor may also become contaminated; and the maintenance of the image forming apparatus may become complicated.

### SUMMARY OF THE INVENTION

It is to be understood that both the foregoing general description of the invention and the following detailed description are exemplary, and are not restrictive of the invention.

In one exemplary embodiment, an image forming apparatus includes: at least one image bearing member configured to bear a toner image on a surface thereof; a transport mechanism having inner and outer surfaces and configured to transport the toner image, the outer surface configured to receive the toner image from the at least one image bearing member; a scale comprising a plurality of thin film marks arranged along the inner surface of the transport mechanism in a moving direction of the transport mechanism; and a scale reading mechanism comprising a magnetometric sensor configured to magnetometrically read the plurality of marks forming the scale.

In another exemplary embodiment, a method of image forming includes: rotating a transport mechanism in a form of an endless belt having inner and outer surfaces; contacting at least one image bearing member with the outer surface of the transport mechanism; magnetometrically reading a scale comprising a plurality of thin film marks arranged along the inner surface of the transport mechanism at predetermined intervals in a moving direction of the transport mechanism; controlling a linear speed of the transport mechanism based on information obtained by the reading; forming a toner image on the at least one image bearing member; and transferring the toner image from the at least one image bearing member onto the outer surface of the transport mechanism.

In another exemplary embodiment, an image transferring mechanism includes: a transport mechanism having inner and outer surfaces and configured to transport the toner image, the outer surface configured to receive the toner image; a scale comprising a plurality of thin film marks arranged along the inner surface of the transport mechanism at predetermined intervals in a moving direction of the transport mechanism; and a scale reading mechanism comprising a magnetometric sensor configured to magnetometrically read the plurality of marks forming the scale.

In another exemplary embodiment, a method of scale reading includes: rotating a transport mechanism arranged in a form of an endless belt and configured to receive a toner image from an image bearing member; and magnetometrically reading a scale comprising a plurality of thin film marks arranged along an inner surface of the transport mechanism at predetermined intervals in a moving direction of the transport mechanism.

In another exemplary embodiment, a belt transfer unit includes: a transport mechanism having inner and outer surfaces and configured to transport the toner image, the outer surface configured to receive a toner image from at least one image bearing member; a scale comprising a plurality of thin film marks arranged along the inner surface of the transport mechanism at predetermined intervals in a moving direction of the transport mechanism; and a scale reading mechanism comprising a magnetometric sensor configured to magnetometrically read the plurality of marks forming the scale.

### BRIEF DESCRIPTION OF THE DRAWINGS

A more complete appreciation of the disclosure will be readily obtained as the same becomes better understood by reference to the following detailed description when considered in connection with the accompanying drawings, wherein:

FIG. 1 is a schematic front view of an exemplary image forming apparatus according to an exemplary embodiment of the present invention;

FIG. 2 is a schematic perspective view illustrating a position of a scale on a transfer member and a position of a corresponding sensor according to an exemplary embodiment of the present invention;

FIG. 3A is a fragmentary cross sectional view of a detailed position of a scale on a transfer belt and a corresponding sensor of FIG. 2;

FIG. 3B is a partial view of a scale on a transfer belt viewed from the top of the transfer belt of FIG. 3A;

FIG. 4 is a schematic front view of an image forming apparatus according to an exemplary embodiment of the present invention, as applied to a tandem type apparatus; and

FIG. 5 is a schematic perspective view of the image forming apparatus according to an exemplary embodiment of the present invention, as applied to a one-drum type apparatus.

### DETAILED DESCRIPTION OF EXEMPLARY EMBODIMENTS

In describing the embodiments of the present invention illustrated in the drawings, specific terminology is employed for clarity. However, the disclosure of this patent specification is not intended to be limited to the specific terminology so selected and it is to be understood that each specific element includes all equivalents.

Referring now to the drawings, wherein like reference numerals designate identical or corresponding parts throughout the several views, exemplary embodiments of the present invention are described.

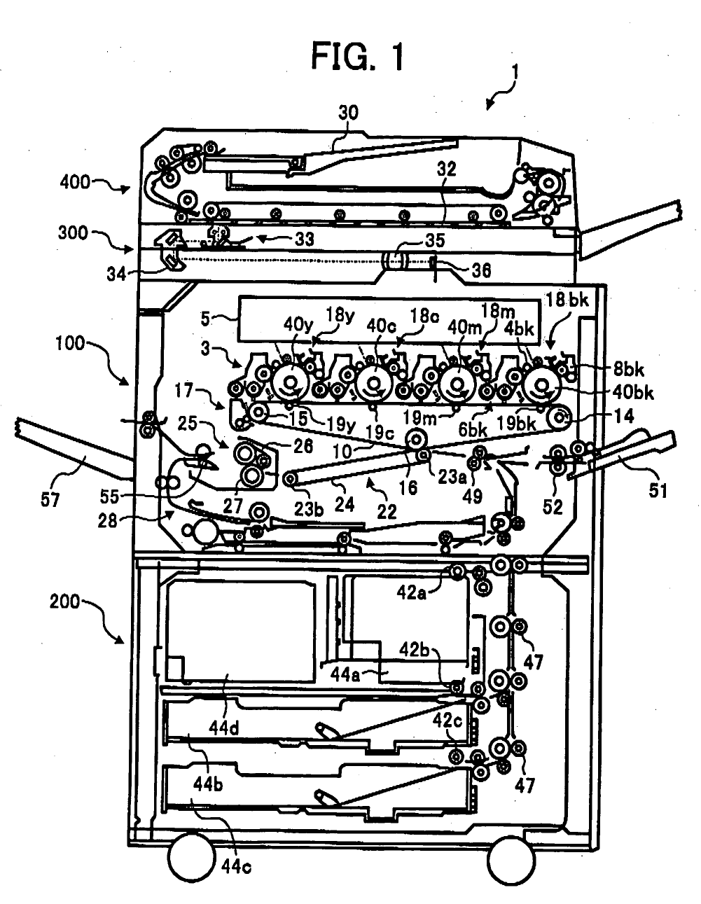

Referring to FIG. 1, a structure of a color image forming apparatus 1 according to an exemplary embodiment of the present invention is now described.

The color image forming apparatus 1 of FIG. 1 is a tandem-type image forming apparatus employing an indirect transfer system.

The color image forming apparatus 1 includes a color image forming engine 100, a sheet feeding table 200, an image scanner 300, and an automatic document feeder (ADF) 400.

The color image forming engine 100 is disposed on the sheet feeding table 200. The image scanner 300 is provided on the upper surface of the color image forming engine 100. The ADF 400 is provided on the top of the image scanner 300.

In FIG. 1, the color image forming engine 100 can include an intermediate transfer member 10 that is provided in an image transfer mechanism, four image forming units 18y, 18c, 18m, and 18bk serving as a tandem-type image forming mechanism 3, a writing unit 5 serving as a writing mechanism, a fixing unit 25 serving as a fixing mechanism, and a portion of a sheet feeding mechanism that is mainly disposed in the sheet feeding table 200.

The four image forming units 18y, 18c, 18m, and 18bk of the tandem-type image forming mechanism 3 can have similar structures and functions, except that the toners are different colors having a relationship of separation color and complementary color to each other to form yellow images, cyan images, magenta images, and black images, respectively. Since the four image forming units 18y, 18c, 18m, and 18bk have similar structures to each other, the image forming unit 18bk is focused on to describe image forming components included therein. That is, the image forming unit 18bk includes a photoconductive drum 40bk m, a charging unit 4bk, a developing unit 6bk, a primary transfer unit 19bk, a drum cleaning unit 8bk, and so forth. These image forming components are arranged around the photoconductive drum 40bk.

The four image forming units 18y, 18c, 18m, and 18bk are separately arranged at positions having horizontal heights or elevations forming the tandem-type image forming mechanism 3. The four image forming units 18y, 18c, 18m, and 18bk of the tandem-type image forming mechanism 3 include photoconductive drums 40y, 40c, 40m, and 40bk, respectively, as electrostatic latent image bearing members. The photoconductive drums 40y, 40c, 40m, and 40bk rotate in a same direction, that is, in a counterclockwise direction in FIG. 1, and separately receive respective light beams emitted by the writing unit 5, such that electrostatic latent images are formed on the respective surfaces of the four photoconductive drums 40y, 40c, 40m, and 40bk.

Respective charging units, which include the charging unit 4bk, are held in contact with the respective photoconductive drums 40y, 40c, 40m, and 40bk to charge respective surfaces of the photoconductive drums 40y, 40c, 40m, and 40bk.

The writing unit 5 is provided at a position above the tandem-type image forming mechanism 3. The writing unit 5 reads image data of an original document placed in the image scanner 300 or image data output from an external computer (not shown), and controls the light beams to form respective electrostatic latent images on respective surfaces of the photoconductive drums 40y, 40c, 40m, and 40bk, which are previously charged by the respective charging units.

Respective developing units, which include the developing unit 6bk, are separately disposed in a vicinity of or adjacent to the four image forming units 18y, 18c, 18m, and 18bk, respectively. The respective developing units contain the different colored toners for the respective image forming units 18y, 18c, 18m, and 18bk.

The respective electrostatic latent images formed on the respective surfaces of the photoconductive drums 40y, 40c, 40m, and 40bk are developed by the respective developing units as respective toner images, and are transferred onto the intermediate transfer member 10 to form an overlaid toner image. The overlaid toner image is then transferred onto a recording sheet.

The fixing unit 25 is positioned at a lower left side of the color image forming engine 100, in a vicinity of the driven roller 23b and below the supporting roller 15. The fixing unit 25 includes a fixing belt 26 and a pressure roller 27, and is configured to press the pressure roller 27 against the fixing belt 26 that is an endless belt.

The image transfer mechanism, which includes the intermediate transfer member 10, is located or disposed below the tandem-type image forming mechanism 3 (substantially at the center of the color image forming apparatus 1). The intermediate transfer member 10 is a transport mechanism forming an endless belt and is passed over or surrounds a plurality of supporting rollers 14, 15, and 16, and is driven to rotate clockwise in FIG. 1. A surface area of the intermediate transfer member 10 supported between the one pair of supporting rollers 14 and 15 is tensioned in a horizontal direction and is held in contact with the photoconductive drums 40y, 40c, 40m, and 40bk. The supporting roller 16 is arranged to face a secondary transfer unit 22, which will be described later.

The intermediate transfer member 10 is formed of a base layer that is coated with an inextensible fluorine resin or an extensible rubber applied to an inextensible material such as a canvas. Provided on the base layer is an elastic layer. The elastic layer can be made of, for example, a fluororubber or acrylonitrile-butadiene copolymer rubber. The surface of the elastic layer can be covered with a smooth coat layer by coating a fluorine resin, for example.

In FIG. 1, an intermediate transfer member cleaning unit 17 is provided in the left side of the supporting roller 15. The intermediate transfer member cleaning unit 17 removes residual toner on the intermediate transfer member 10 after image formation.

Four primary transfer units 19y, 19c, 19m, and 19bk are disposed inside a loop of the intermediate transfer member 10 to face the respective photoconductive drums 40y, 40c, 40m, and 40bk, which are accommodated in the image forming units 18y, 18c, 18m, and 18bk.

The primary transfer units 19y, 19c, 19m, and 19bk form a primary transfer portion to perform a primary transfer operation in which the respective single toner images formed on respective surfaces of the photoconductive drums 40y, 40c, 40m, and 40bk are sequentially transferred onto the surface of the intermediate transfer member 10 that is previously charged so that an overlaid color toner image is formed on the surface of the intermediate transfer member 10.

The secondary transfer unit 22 is located on the opposite side of the intermediate transfer member 10 from the tandem type image forming mechanism 3. The secondary transfer unit 22 includes a secondary transfer belt 24 that is an endless belt, and the transfer belt 24 is extended between a charge driving roller 23a and a driven roller 23b. The secondary transfer unit 22 is arranged such that a portion of the secondary transfer belt 24, which is close to the charge driving roller 23a, presses the intermediate transfer member 10 against the supporting roller 16. The secondary transfer unit 22 forms a secondary transfer portion to perform a secondary transfer operation. When a recording sheet is conveyed to a portion between the supporting roller 16 and the charge driving roller 23a of the secondary transfer belt 24, the overlaid color toner image formed on the surface of the intermediate transfer member 10 or respective single color images may be transferred onto a recording sheet.

In the color image forming apparatus 1 of FIG. 1, the color image forming engine 100 is further provided with a sheet reverse unit 28 for reversing a recording sheet on one side of which an image is formed. Another image can be formed on the other side of a recording sheet for a duplex image forming operation in a duplex copy mode. The sheet reverse unit 28 is arranged under the secondary transfer unit 22 and the fixing unit 25, and is substantially parallel to the image forming mechanism 3.

While the color image forming engine 100 includes several components, such as a pair of registration rollers 49 serving as the sheet feeding mechanism, which will be described below, the sheet feeding mechanism is mainly arranged in the sheet feeding table 200.

The sheet feeding table 200, serving as the sheet feeding mechanism, is arranged in a lower portion of the color image forming apparatus 1, and includes: sheet feeding rollers 42a, 42b, and 42c; sheet feeding cassettes 44a, 44b, 44c, and 44d; a plurality of sheet feeding rollers 47; and the pair of registration rollers 49.

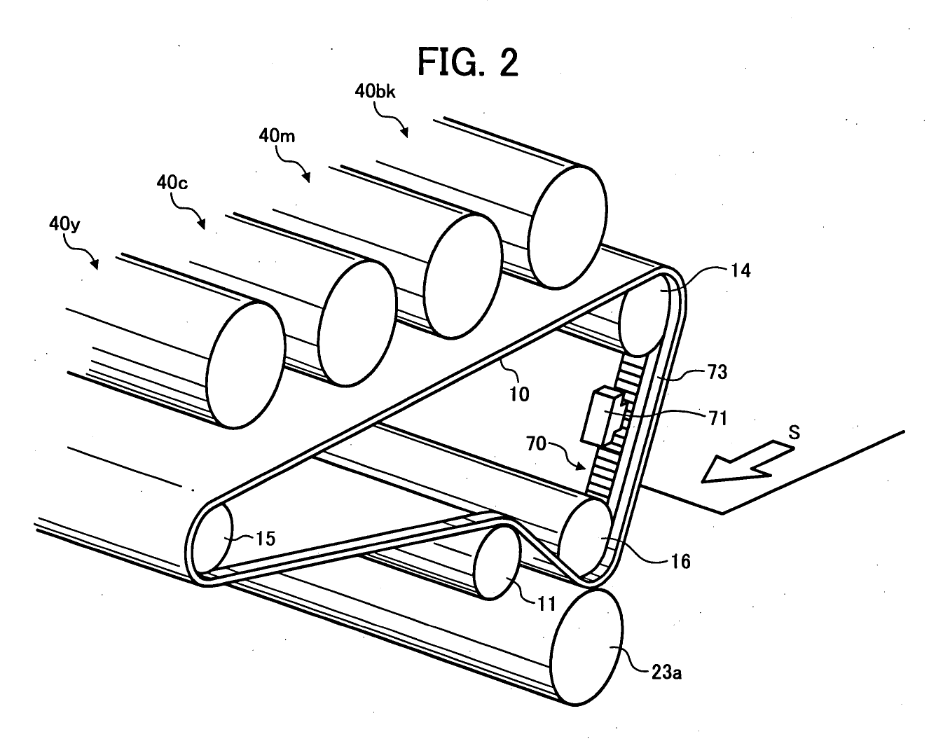

The sheet feeding cassettes 44a, 44b, 44c, and 44d are loaded with a stack of sheets of particular size, including a recording sheet S (shown in FIG. 2). When an image forming operation is performed, the recording sheet is fed from one of the sheet feeding cassettes 44a, 44b, 44c, and 44d and is conveyed toward the pair of registration rollers 49.

The sheet feeding mechanism also includes a manual sheet feeding tray 51, a switch pawl 55, and a sheet discharging tray 57. These components can provide a sheet transporting passage in addition to a sheet transporting passage via the sheet feeding cassettes 44a, 44b, 44c, and 44d, so that a recording sheet that is not loaded in the sheet feeding cassettes 44a, 44b, 44c, and 44d can be supplied.

The manual sheet feeding tray 51 is mounted on the right side of the color image forming engine 100 of FIG. 1, and includes sheet separation rollers 52. After opening the manual sheet feeding tray 51, an operator of the color image forming apparatus 1 may feed sheets by hand. The sheet transporting passages may merge at a predetermined position before the pair of registration rollers 49.

The image scanner 300 includes an original document stacker 30 and a contact glass 32.

The image scanner 300 also includes first and second moving units 33 and 34, an image forming lens 35, and an image reading sensor 36.

The first moving unit 33 includes a light source. The second moving unit 34 includes reflection mirrors and is movable according to a predetermined speed ratio with respect to the first moving unit 33. The image forming lens 35 receives light reflected by the original document and sends an image to the image reading sensor 36.

The ADF 400 is openable with respect to the original document stacker 30, and reverses the original document conveyed to the original document stacker 30 so that both sides of the original document may be scanned.

Operations of the above-described color image forming apparatus 1 are now described.

The above-described color image forming apparatus 1 obtains image data by optically scanning an original document placed on the ADF 400 or placed on the contact glass 32 of the image scanner 300 or by receiving the image data from the external computer.

When scanning the original document placed on the ADF 400 or the contact glass 32, the first and second moving units 33 and 34 of the image scanner 300 slide in a predetermined direction.

The first moving unit 33 causes a light beam to emit and deflects the light beam reflected by the original document. The second moving unit 34 receives the light beam reflected by the first moving unit 33 and reflects the light beam to the image reading sensor 36 via the image forming lens 35.

In the belt transport mechanism, one of the supporting rollers 14, 15, and 16 is driven to rotate the other two rollers. This causes the intermediate transfer member 10 to rotate. Subsequently, the image forming units 18y, 18c, 18m, and 18bk are driven to rotate the corresponding photoconductive drums 40y, 40c, 40m, and 40bk. This forms single color images in yellow, cyan, magenta, and black on the respective photoconductive drums 40y, 40c, 40m, and 40bk in the image forming mechanism 3.

When the color image forming apparatus 1 receives full color image data, each of the photoconductive drums 40y, 40c, 40m, and 40bk rotates in a clockwise direction in FIG. 1 and is uniformly charged with the corresponding charging units (e.g, the charging unit 4bk). The writing unit 5 emits the light beams corresponding to the respective color image data and irradiates the photoconductive drums 40y, 40c, 40m, and 40bk of the image forming units 18y, 18c, 18m, and 18bk, respectively. Electrostatic latent images corresponding to the respective color image data are formed on respective surfaces of the photoconductive drums 40y, 40c, 40m, and 40bk. The electrostatic latent images formed on the respective photoconductive drums 40y, 40c, 40m, and 40bk are developed by the respective developing units (e.g., the developing unit 6bk), which contain respective color toners therein, into yellow, cyan, magenta, and black toner images, respectively. Those color toner images are sequentially overlaid on the surface of the intermediate transfer member 10 such that a composite color image is formed on the surface of the intermediate transfer member 10.

When the original document is scanned, a size of a copy sheet is determined. The recording sheet S having a size equivalent to that of the copy sheet is fed from a corresponding one of the sheet feeding cassettes 44a, 44b, 44c, and 44d and is conveyed by the plurality of sheet feeding rollers 47 to the pair of registration rollers 49.

When manual insertion is used, a set of recording sheets placed on the manual sheet feeding tray 51 is fed and conveyed to the pair of sheet separation rollers 52. Then, the pair of sheet separation rollers 52 separates an uppermost recording sheet from the set of recording sheets placed on the manual sheet feeding tray 51 and transfers the uppermost recording sheet (e.g., the recording sheet S) to the pair of registration rollers 49.

Then, the pair of registration rollers 49 stops and feeds the recording sheet S in synchronization with a movement of the composite color image towards a transfer area formed between the intermediate transfer member 10 and the secondary transfer unit 22. In particular, the transfer area is formed between a portion where the intermediate transfer member 10 is supported by the supporting roller 16 and a portion where the secondary transfer unit 22 is supported by the secondary transfer roller 23a. The composite color image formed on the surface of the intermediate transfer member 10 is transferred onto the recording sheet S at the transfer area.

The recording sheet S that has the composite color image thereon is further conveyed and passes through the fixing unit 25. The fixing unit 25 fixes the composite color image to the recording sheet S by applying heat and pressure.

As an alternative, the recording sheet S may be sent to the sheet reverse unit 28 when the switch pawl 55 selects the sheet transporting passage for the duplex image forming operation. When the duplex image forming operation is performed, the sheet reverse unit 28 receives the recording sheet S, on one side of which an image is formed. Recording sheet S is fed to the sheet reverse unit 28 after the recording sheet S is switched back to the face-down orientation at the sheet transporting passage of the sheet reverse unit 28. The sheet reverse unit 28 then transports the recording sheet S to the pair of registration rollers 49 to pass through the transfer area formed between the intermediate transfer member 10 and the secondary image transfer unit 22 so that a next composite color image is transferred onto the back surface of the recording sheet S. Then, the recording sheet S, having composite color images printed on the front and back sides, is conveyed to the fixing unit 25.

After the recording sheet S passes through the fixing unit 25, the recording sheet S passes through a discharging passage selected by a switch pawl 55 and is discharged to a sheet discharging tray 57.

After the composite color image is transferred onto the recording sheet S, the intermediate transfer member cleaning unit 17 removes residual toner on the surface of the intermediate transfer member 10 before a next image forming operation.

Referring now to FIG. 2, an exemplary structure and operation of the image transfer mechanism is described.

As previously shown in FIG. 1, the intermediate transfer member 10 of the image transfer mechanism is held in contact with the tandem-type image forming mechanism 3 including the plurality of photoconductive drums 40y, 40c, 40m, and 40bk and the secondary transfer unit 22 (see FIG. 1) including the charge driving roller 23a, and is supported by the supporting rollers 14, 15, and 16.

In FIG. 2, the image transfer mechanism further includes a tension roller 11. The tension roller 11 is arranged to be held in contact with a surface area of the intermediate transfer member 10 in a vicinity of a surface area held in contact with the supporting roller 16. The tension roller 11 contacts a surface side of the intermediate transfer member 10 that is an opposite side the supporting roller 16 contacts.

In FIG. 2, the intermediate transfer member 10 includes a linear scale 70, a scale reading sensor 71, and a regulating member 73.

The linear scale 70 is provided in a vicinity of one end of the intermediate transfer member 10. The linear scale 70 is formed on an inner circumferential surface (e.g., a base layer) of the intermediate transfer member 10 over the entire circumference thereof.

The scale reading sensor 71 is arranged at a portion between the supporting rollers 14 and 16, oppositely facing a surface of the linear scale 70.

The regulating member 73 is integrally provided on one end in a width direction of the inner surface of the intermediate transfer member 10, along the inner circumferential surface of the intermediate transfer member 10. The regulating member 73 has a predetermined height so that a side surface of the regulating member 73 having the predetermined height can contact with one side surface of each of the supporting rollers 14, 15, and 16 to prevent a misalignment in a direction parallel to a rotating axis of each of the supporting rollers 14, 15, and 16.

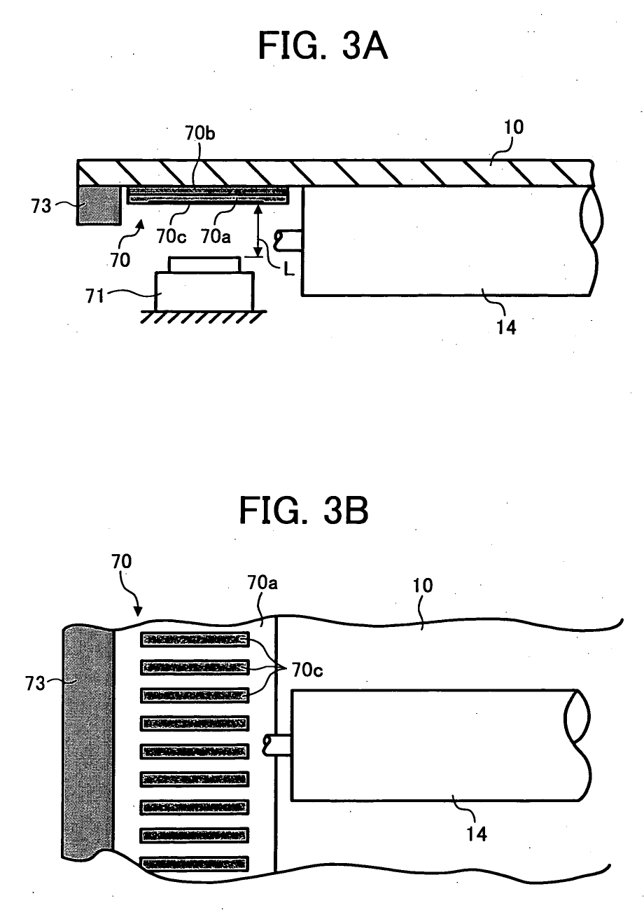

Referring now to FIGS. 3A and 3B, an exemplary structure of the linear scale 70 is described.

As shown in FIG. 3A, the linear scale 70 includes a film layer 70a, an adhesive layer 70b, and a plurality of encoder marks 70c.

In this exemplary embodiment the film layer 70a includes nonmetallic resin material. The adhesive layer 70b is formed to attach the film layer 70a onto either surface side of the intermediate transfer member 10. In this exemplary embodiment, the adhesive layer 70b is applied on the base layer of the intermediate transfer member 10.

In this exemplary embodiment the plurality of encoder marks 70c include an aluminum thin layer having a ladder-shaped scale pattern, and are arranged on the film layer 70a at predetermined intervals over the entire circumference of the intermediate transfer member 10 as shown in FIG. 3B. However, metallic compounds, non-metallic compounds, and combination compounds thereof may be utilized for the plurality of marks. Further, any shape, material, and thickness may be employed which provide sufficient readability, strength, durability, and pliability. The form and construction of the encoder marks 70c is limited only by their compatibility with a chosen intermediate transfer member and scale reading sensor; and not limited to their compatibility with the above-described intermediate transfer member 10 and scale reading sensor 71, as those descriptions are exemplary.

In FIG. 3A, a micro magnetic sensor 71 is disposed facing the film layer 70a at a predetermined distance L from the film layer 70a. The micro magnetic sensor 71 serves as a magnetometric scale reading mechanism and detects the plurality of encoder marks 70c of the linear scale 70. According to the signals output by the micro magnetic sensor 71, a variation in speed of reading the plurality of encoder marks 70c may be obtained so that a change of a linear speed of the intermediate transfer member 10 or a change of a position of the intermediate transfer member 10 can be output.

With the above-described structure, the linear scale 70 begins to move at the start of a rotation of the intermediate transfer member 10, and a time interval of the plurality of encoder marks 70c is read by the micro magnetic sensor 71 to output the signals.

According to the signals from the micro magnetic sensor 71, a control portion (not shown) provided in the color image forming apparatus 1 detects the linear speed of the intermediate transfer member 10. When the linear speed is out of a predetermined range, that is, when the plurality of respective photoconductive drums 40y, 40c, 40m, and 40bk have variations in respective positions to transfer respective color toner images, the control portion performs a feedback control with respect to a drive roller (not shown) of the intermediate transfer member 10 to adjust the linear speed of the intermediate transfer member 10, so that a color shift due to misalignment of the respective color toner images can be prevented.

Since the micro magnetic sensor 71 and the linear scale 70 are shielded by the intermediate transfer member 10, a deterioration in reading accuracy of the micro magnetic sensor 71 caused by contamination due to toner dust may be prevented. Further, the plurality of encoder marks 70c of the linear scale 70 may be applied to both a clear surface and a reflective surface of the intermediate transfer member 10. With the above-described structure, the micro magnetic sensor 71 can read the linear scale 70 with accuracy; thereby, cost, misalignment, and color shift of the color toner images can be reduced.

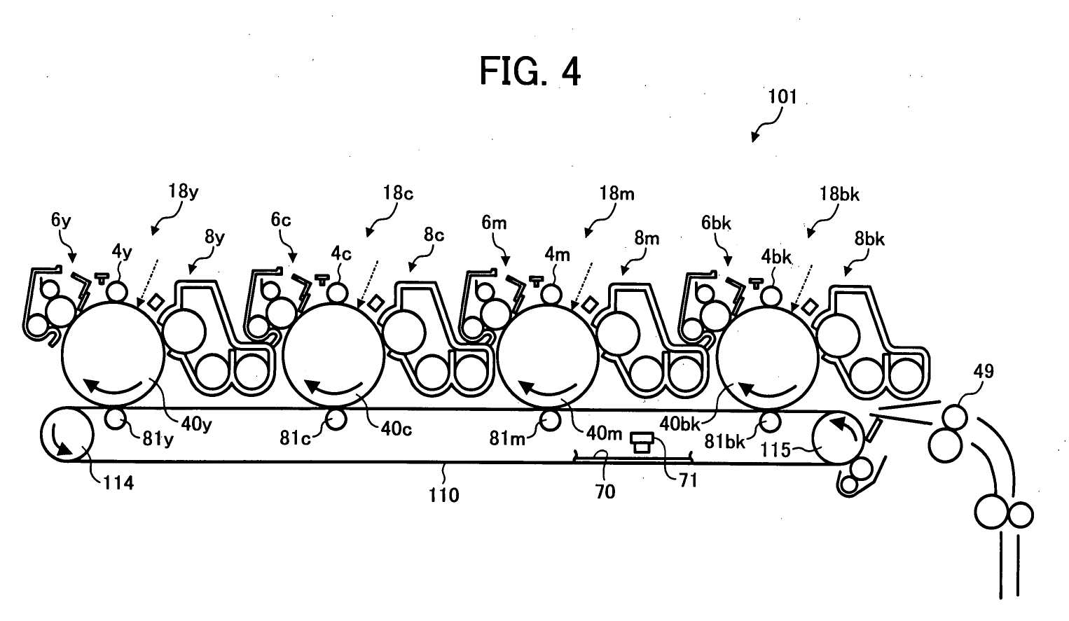

Referring to FIG. 4, an exemplary tandem-type color image forming apparatus 101 with a tandem-type direct transfer system is now described.

In the discussion below, components of the tandem-type color image forming apparatus 101 having similar functions to those of components of the tandem-type color image forming apparatus 100 shown in FIG. 1 are given the same reference numerals.

In the direct transfer system, four image forming units 18y, 18c, 18m, and 18bk and a sheet conveyance belt 110 are arranged horizontally to each other.

The four image forming units 18y, 18c, 18m, and 18bk include respective image forming components, such as the photoconductive drums 40y, 40c, 40m, and 40bk, the charging units 4y, 4c, 4m, and 4bk, the developing units 6y, 6c, 6m, and 6bk, and the drum cleaning units 8y, 8c, 8m, and 8bk.

The sheet conveyance belt 110 serving as a recording medium carrying member is supported by supporting rollers 114 and 115 in a form of an endless belt and is held in contact with the photoconductive drums 40y, 40c, 40m, and 40bk.

The direct transfer system also includes four transfer units 81y, 81c, 81m, and 81bk for sequentially transferring images formed on respective photoconductive drums 40y, 40c, 40m, and 40bk onto a recording sheet (not shown) conveyed through the pair of registration rollers 49.

In FIG. 4, a part of the linear scale 70 and the micro magnetic sensor 71 are disposed within a loop of the sheet conveyance belt 110. The linear scale 70 and the micro magnetic sensor 71 shown in FIG. 4 may be disposed the same as the linear scale 70 and the micro magnetic sensor 71 as shown in FIGS. 3A and 3B. That is, the micro magnetic sensor 71 can read encoder marks (not shown) of the linear scale 70.

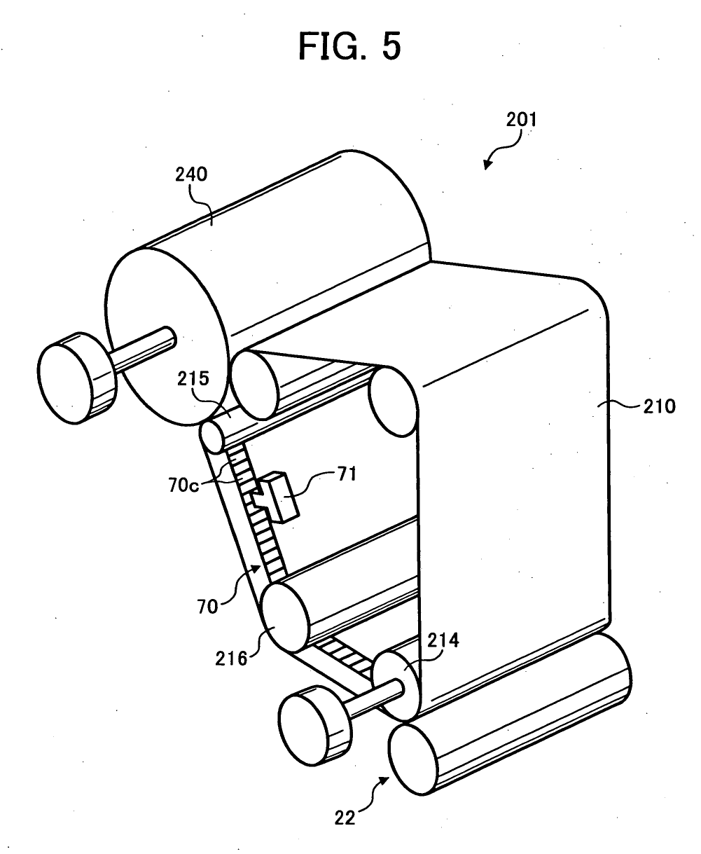

Referring to FIG. 5, an exemplary one-drum type color image forming apparatus 201 is described.

In the discussion below, components of the one-drum type color image forming apparatus 201 having similar functions to those of components of the tandem-type color image forming apparatus 1 shown in FIG. 1 are given the same reference numerals.

The one-drum type color image forming apparatus 201 repeats four cycles of image forming operations to produce a full-color image.

An intermediate transfer belt 210 is supported by a plurality of supporting rollers including supporting rollers 214, 215, and 216.

In one cycle of the image forming operations, a drum-shaped photoconductive element 240 bears an electrostatic latent image of a single color on a surface thereof. The electrostatic latent image formed according to image data corresponding to the single color is developed as a toner image, and is transferred onto the intermediate transfer member 10 to form a composite color image. After four cycles of image forming operations similar to those as described above are performed, the composite color image on the intermediate transfer member 10 is transferred onto a recording sheet (not shown) by the secondary transfer unit 22 to obtain a full-color image.

In FIG. 5, the linear scale 70 including the plurality of encoder marks 70c is arranged over the entire circumference of the intermediate transfer member 210, and the micro magnetic sensor 71 is disposed facing the linear scale 70 between the supporting rollers 215 and 216. The linear scale 70 and the micro magnetic sensor 71 shown in FIG. 5 may be disposed the same as the linear scale 70 and the micro magnetic sensor 71 as shown in FIGS. 3A and 3B. That is, the micro magnetic sensor 71 can read the plurality of encoder marks 70c of the linear scale 70.

Accordingly, the above-described techniques according to the present invention may be effectively applied to a transfer mechanism to maintain a reading accuracy against aging even in the environment contaminated by toner dust and to prevent a misalignment, that is, a color shift, of a plurality of color toner images in a transfer operation. The above-described embodiments are exemplary, and numerous additional modifications and variations are possible in light of the above teachings. For example, features of different exemplary embodiments herein may be combined with each other and/or substituted for each other within the scope of this disclosure and appended claims. It is therefore to be understood that the disclosure of this patent specification may be practiced otherwise than as described herein.

1. An image forming apparatus, comprising:
at least one image bearing member configured to bear a toner image on a surface thereof;
a transport mechanism having inner and outer surfaces and configured to transport the toner image, the outer surface configured to receive the toner image from the at least one image bearing member;
a scale comprising a plurality of thin film marks arranged along the inner surface of the transport mechanism at predetermined intervals in a moving direction of the transport mechanism; and
a scale reading mechanism comprising a magnetometric sensor configured to magnetometrically read the plurality of marks forming the scale.

2. The image forming apparatus according to claim 1, wherein the plurality of thin film marks are metallic.

3. The image forming apparatus according to claim 2, wherein the plurality of thin film makes are aluminum.

4. The image forming apparatus according to claim 1, wherein the scale further comprises a nonmetallic thin film arranged between the inner surface of the transport mechanism and the plurality of marks forming the scale.

5. The image forming apparatus according to claim 1, wherein the at least one image bearing member is arranged in contact with the transport mechanism along the outer surface of the transport mechanism.

6. The image forming apparatus according to claim 1, wherein the transport mechanism comprises:
an intermediate transfer member arranged in a form of an endless belt and configured to receive the toner image from the at least one image bearing member.

7. The image forming apparatus according to claim 6, further comprising:
a primary transferring mechanism configured to transfer the toner image from the at least one image bearing member to the intermediate transfer member; and
a secondary transferring mechanism configured to transfer the toner image from the intermediate transfer member onto a recording medium.

8. The image forming apparatus according to claim 5, wherein the transport mechanism comprises a recording medium carrying member arranged in a form of an endless belt and configured to carry a recording medium to directly receive the toner image from the at least one image bearing member.

9. An image forming apparatus, comprising:
means for carrying a toner image on a surface thereof;
means for transporting the toner image, the means for transporting having (1) an inner surface and (2) an outer surface configured to receive the toner image from the means for carrying;
means for indicating a linear speed of the means for transporting, the means for indicating comprising a plurality of thin film marks arranged along the inner surface of the means for transporting at predetermined intervals in a moving direction of the means for transporting; and
means for magnetometrically reading the plurality of marks forming the means for indicating.

10. The image forming apparatus according to claim 9, wherein the plurality of thin film marks are metallic.

11. The image forming apparatus according to claim 10, wherein the plurality of thin film marks are aluminum.

12. The image forming apparatus according to claim 9, wherein the means for indicating further comprises a nonmetallic thin film arranged between the inner surface of the means for transporting and the plurality of marks forming the means for indicating.

13. The image forming apparatus according to claim 9, wherein the means for carrying is arranged in contact with the means for transporting along the outer surface of the means for transporting.

14. The image forming apparatus according to claim 7, wherein the means for transporting comprises:
means for receiving the toner image from the means for carrying.

15. The image forming apparatus according to claim 14, further comprising:
means for transferring the toner image from the means for carrying to the means for receiving; and
means for transferring the toner image from the means for receiving onto a recording medium.

16. The image forming apparatus according to claim 13, wherein the means for transporting comprises:
means for conveying a recording medium to directly receive the toner image from the means for carrying.

17. A method of image forming, comprising:
rotating a transport mechanism in a form of an endless belt having inner and outer surfaces;
contacting at least one image bearing member with the outer surface of the transport mechanism;
magnetometrically reading a scale comprising a plurality of thin film marks arranged along the inner surface of the transport mechanism at predetermined intervals in a moving direction of the transport mechanism;
controlling a linear speed of the transport mechanism based on information obtained by the reading;
forming a toner image on the at least one image bearing member; and
transferring the toner image from the at least one image bearing member onto the outer surface of the transport mechanism.

18. The method according to claim 17, wherein the plurality of thin film marks are metallic.

19. The method according to claim 18, wherein the plurality of thin film marks are aluminum.

20. The method according to claim 17, wherein the transferring comprises:
receiving the toner image from the at least one image bearing member onto the transport mechanism; and
transferring the toner image from the transport mechanism onto a recording medium.

21. The method according to claim 17, wherein the transferring comprises:
carrying a recording medium on the transfer mechanism; and
receiving the toner image from the at least one image bearing member directly onto the recording medium.

22. An image transferring mechanism, comprising:
a transport mechanism having inner and outer surfaces and configured to transport a toner image, the outer surface configured to receive the toner image;
a scale comprising a plurality of thin film marks arranged along the inner surface of the transport mechanism at predetermined intervals in a moving direction of the transport mechanism; and
a scale reading mechanism comprising a magnetometric sensor configured to magnetometrically read the plurality of marks forming the scale.

23. The image transferring mechanism according to claim 22, wherein the plurality of thin film marks are metallic.

24. The image transferring mechanism according to claim 23, wherein the plurality of thin film marks are aluminum.

25. The image transferring mechanism according to claim 22, wherein the scale further comprises a nonmetallic thin film arranged between the inner surface of the transport mechanism and the plurality of marks forming the scale.

26. The image transferring mechanism according to claim 22, wherein the transport mechanism comprises:
an intermediate transfer member arranged in a form of an endless belt and configured to receive the toner image from at least one image bearing member.

27. The image transferring mechanism according to claim 26, further comprising:
a primary transferring mechanism configured to transfer the toner image from the at least one image bearing member to the intermediate transfer member; and
a secondary transferring mechanism configured to transfer the toner image from the intermediate transfer member onto a recording medium.

28. The image transferring mechanism according to claim 22, wherein the transport mechanism comprises a recording medium carrying member arranged in a form of an endless belt and configured to carry a recording medium to directly receive the toner image from at least one image bearing member.

29. An image transferring mechanism, comprising:
means for transporting a toner image, the means for transporting including (1) an inner surface and (2) an outer surface configured to receive the toner image;
means for indicating a linear speed of the means for transporting, the means for indicating including a plurality of thin film marks arranged along the inner surface of the means for transporting at predetermined intervals in a moving direction of the means for transporting; and
means for magnetomerically reading information indicated by the plurality of marks forming the means for indicating.

30. The image transferring mechanism according to claim 29, wherein the plurality of thin film marks are metallic.

31. The image transferring mechanism according to claim 30, wherein the plurality of thin film marks are aluminum.

32. The image transferring mechanism according to claim 29, wherein the means for indicating further comprises a nonmetallic thin film formed between the inner surface of the means for transporting and the plurality of marks forming the means for indicating.

33. The image transferring mechanism according to claim 29, wherein the means for transporting comprises:
means for receiving the toner image from means for carrying the toner image.

34. The image transferring mechanism according to claim 33, further comprising:
means for transferring the toner image from the means for carrying to the means for receiving; and
means for transferring the toner image from the means for receiving onto a recording medium.

35. The image transferring mechanism according to claim 32, wherein the means for transporting comprises:
means for conveying a recording medium to directly receive the toner image from the means for carrying.

36. A method of scale reading, comprising:
rotating a transport mechanism arranged in a form of an endless belt and configured to receive a toner image from an image bearing member; and
magnetometrically reading a scale comprising a plurality of thin film marks arranged along an inner surface of the transport mechanism at predetermined intervals in a moving direction of the transport mechanism.

37. The method according to claim 36, further comprising:
shielding a scale reading mechanism, via the transport mechanism, from toner dust produced by development of the image bearing member.

38. A belt transfer unit, comprising:
a transport mechanism having inner and outer surfaces and configured to transport the toner image, the outer surface configured to receive a toner image from at least one image bearing member;
a scale comprising a plurality of thin film marks arranged along the inner surface of the transport mechanism at predetermined intervals in a moving direction of the transport mechanism; and
a scale reading mechanism comprising a magnetometric sensor configured to magnetometrically read the plurality of marks forming the scale.

39. The belt transfer unit according to claim 38, wherein the plurality of thin film marks are metallic.

40. The belt transfer unit according to claim 39, wherein the plurality of thin film marks are aluminum.

41. The belt transfer unit according to claim 38, wherein the scale further comprises a nonmetallic thin film arranged between the inner surface of the transport mechanism and the plurality of marks forming the scale.

42. The belt transfer unit according to claim 38, wherein the transport mechanism comprises:
an intermediate transfer member arranged in a form of an endless belt and configured to receive the toner image from the at least one image bearing member before the toner image is transferred onto a recording medium.

43. The belt transfer unit according to claim 38, wherein the transport mechanism comprises a recording medium carrying member arranged in a form of an endless belt and configured to carry a recording medium to directly receive the toner image from the at least one image bearing member.

44. A belt transfer unit, comprising:
means for transporting having inner and outer surfaces and for transporting the toner image, the outer surface configured to receive a toner image from at least one image bearing member;
means for indicating a linear speed of the means for transporting, the means for indicating comprising a plurality of thin film marks arranged at predetermined intervals along the inner surface of the means for transporting in a moving direction of the means for transporting; and
means for magnetometrically reading information indicated by the plurality of marks forming the means for indicating.

45. The belt transfer unit according to claim 44, wherein the plurality of thin film marks are metallic.

46. The belt transfer unit according to claim 45, wherein the plurality of thin film marks are aluminum.

47. The belt transfer unit according to claim 44, wherein the means for indicating further comprises a nonmetallic thin film formed between the inner surface of the means for transporting and the plurality of marks forming the means for indicating.

48. The belt transfer unit according to claim 44, wherein the means for transporting comprises:
means for receiving the toner image from means for carrying before the toner image is transferred onto a recording medium.

49. The belt transfer unit according to claim 44, wherein the means for transporting comprises means for conveying a recording medium to directly receive the toner image from the means for carrying.
